(19) United States
(12) Patent Application Publication
(10) Pub. No.: US 2015/0185106 A1
(43) Pub. Date: Jul. 2, 2015

(54) MACHINE AND METHOD FOR BALANCING THE WHEELS OF A VEHICLE

(71) Applicant: M&B ENGINEERING S.R.L., Correggio (RE) (IT)

(72) Inventor: Franco Magnani, Correggio (RE) (IT)

(21) Appl. No.: 14/409,514

(22) PCT Filed: Jun. 19, 2013
(86) PCT No.: PCT/IB2013/001274

§ 371 Date: Dec. 19, 2014

(30) Foreign Application Priority Data
Jun. 20, 2012 (IT) TO2012A000540

(51) Int. Cl. G01M 1/04; G01M 1/26

(52) U.S. Cl. CPC G01M 1/045; G01M 1/26

(57) ABSTRACT

A machine (1) for balancing the wheels of a vehicle, includes a supporting frame (2), at least one shaft (3) associated mobile in rotation with the frame (2) and intended to support a wheel (10), identification elements (5) for identifying at least a balancing plane which locates a balancing profile (6) on the relative rim (11), measurement elements for measuring the unbalance of the wheel, at least an optical device (16) for emitting a luminous beam (17) which locates a luminous point (18) on the surface of the rim for the operator to apply compensation weights to an unbalanced wheel, the optical device including movement elements (20) for moving the luminous beam which can be operated to carry the luminous point in correspondence to the balancing profile and the movement elements being suitable for rotating the luminous beam with respect to the rim around a relative axis (22).

### TECHNICAL FIELD

The present invention relates to a machine and a method for balancing the wheels of a vehicle.

### BACKGROUND ART

As is known, to balance a wheel, suitable calculated compensation weights have to be fitted on its rim.

Such operation requires the identification of at least a balancing plane at right angles to the axis of the relative wheel and which intercepts on same a corresponding balancing profile.

In particular, to perform the static balancing of a wheel, it is enough to identify just one balancing plane, while to perform dynamic balancing, two balancing planes have to be identified spaced from one another along the wheel axis.

Each balancing plane, and therefore also the relative profile, is identified through a number of characteristic geometric parameters of the rim to be balanced, such as the diameter in correspondence to the balancing plane and the distance of the latter from a fixed reference point of the balancing machine.

The identification of the balancing plane or planes can be done by directly contacting the rim in correspondence to the profile along which the compensation weights are to be positioned by means of a mechanical feeler. An electronic measuring system detects the position of the mechanical feeler with respect to a predefined reference system and transmits the detected information to a data processing unit.

Alternatively, the balancing planes can be identified in a fully automatic way by means of an electronic device which, by fully scanning the rim profile, is able to identify the ideal balancing planes.

More in detail, after identifying the balancing planes, the wheel to be balanced is made to rotate around its relative axis and electronic calculation means connected to a measuring device belonging to the balancing machine measure the weight of the compensation weights to be fitted and their angular position along the relative balancing profile.

Subsequently, the operator fits the compensation weights along the balancing profile of the relative rim in correspondence to the identified application point. To make completing this stage easier, an instrument is generally used which identifies a fixed reference area on the rim with respect to the balancing machine and in correspondence to which the compensation weights are to be fitted. The data processing unit is suitably programmed to compare the angular position of the calculated application point with that of the reference area.

When the data processing unit signals that the calculated application areas are in correspondence to the preset reference area, the operator proceeds to fit the compensation weights to the rim.

The aforementioned reference element can be the same mechanical feeler described previously, the position of which is therefore recognized by the electronic measuring system of the balancing machine, or else made up of a laser beam.

In this latter case, the balancing machine comprises a mobile arm parallel to the axis of the wheel to be balanced and having a light source which emits a luminous beam along a direction fixed and predefined with respect to the balancing machine. Such mobile arm thus moves in translation with respect to the rim so that the luminous beam intercepts the identified balancing profiles. In this case as well, the operator fits the compensation weights in correspondence to the area identified by the laser beam when this is angularly aligned with the application areas calculated on the relative balancing profile.

These balancing machines for balancing the wheels do have a number of drawbacks.

The machines of known type do not in fact permit identifying, in an easy and practical way, the reference area in correspondence to which the compensation weights are to be fitted.

It must in fact be noted that in the event of the mechanical feeler being used, the operator must keep the feeler itself in position to ensure precise detection and, at the same time, apply the force needed to fit the compensation weights.

Furthermore, the mechanical feelers are generally configured so they contact the rim in an area which the operator finds it hard to see, thereby making the application operation of the compensation weights even more difficult.

On the other hand, the known wheel balancing machines which have a moving arm supporting a light source are complicated as regards construction and, consequently, costly to make. The reason for this is that such machines must be equipped with a mechanism suitable for moving the arm supporting the light source nearer to and away from the rim.

Furthermore, it should be noted that the movement of such arm alters the overall dimensions of the wheel balancing machine and moves within a space generally exploited by the operator to work on the rim. The result therefore is that the moving arm can interfere with the activity of the operator and complicate the application procedure of the compensation weights.

### DESCRIPTION OF THE INVENTION

The main aim of the present invention is to provide a vehicle wheel balancing machine which allows to make easier, with respect to the known machines, the application procedure of the compensation weights on the rim of the wheel to be balanced.

Within this aim, one object of the present invention is to provide a machine which allows to identify in a simple and practical way the reference area in correspondence to which the operator intends to apply the compensation weights on the rim.

One object of the present invention is to provide a machine which is simpler in terms of construction and which, therefore, is less costly compared to machines of known type which envisage the use of a luminous beam to identify the aforementioned reference area.

Yet another object is to provide a machine which allows to identify on the rim the reference area in correspondence to which the compensation weights are to be applied without interfering in any way with the activity of the operator.

Another object of the present invention is to provide a machine for balancing the wheels of a vehicle which allows to overcome the mentioned drawbacks of the state of the art in the ambit of a simple, rational, easy and effective to use as well as low cost solution.

The above objects are achieved by the present machine for balancing the wheels of a vehicle, comprising:
a supporting frame;
at least one shaft associated mobile in rotation with said frame and intended to support a wheel to be balanced of a vehicle;
identification means for identifying at least a balancing plane arranged substantially at right angles to the axis of the wheel and which locates a balancing profile on the relative rim;
measurement means for measuring the unbalance of the wheel;
at least an optical device suitable for emitting a luminous beam which locates a luminous point on the surface of the rim, wherein said luminous point is suitable for identifying a fixed reference position compared to the machine itself and in correspondence to which the operator wishes to apply the compensation weights for the unbalance of the wheel; said optical device comprising movement means for moving the luminous beam which can be operated to carry said luminous point in correspondence to said balancing profile;
   characterized by the fact that said movement means are suitable for rotating said luminous beam with respect to said rim around a relative axis.

### BRIEF DESCRIPTION OF THE DRAWINGS

Other characteristics and advantages of the present invention will become more evident from the description of a preferred, but not sole, embodiment of a machine for balancing the wheels of a vehicle, illustrated purely as an example but not limited to the annexed drawings in which:

FIG. 1 is a perspective view of a machine according to the invention;

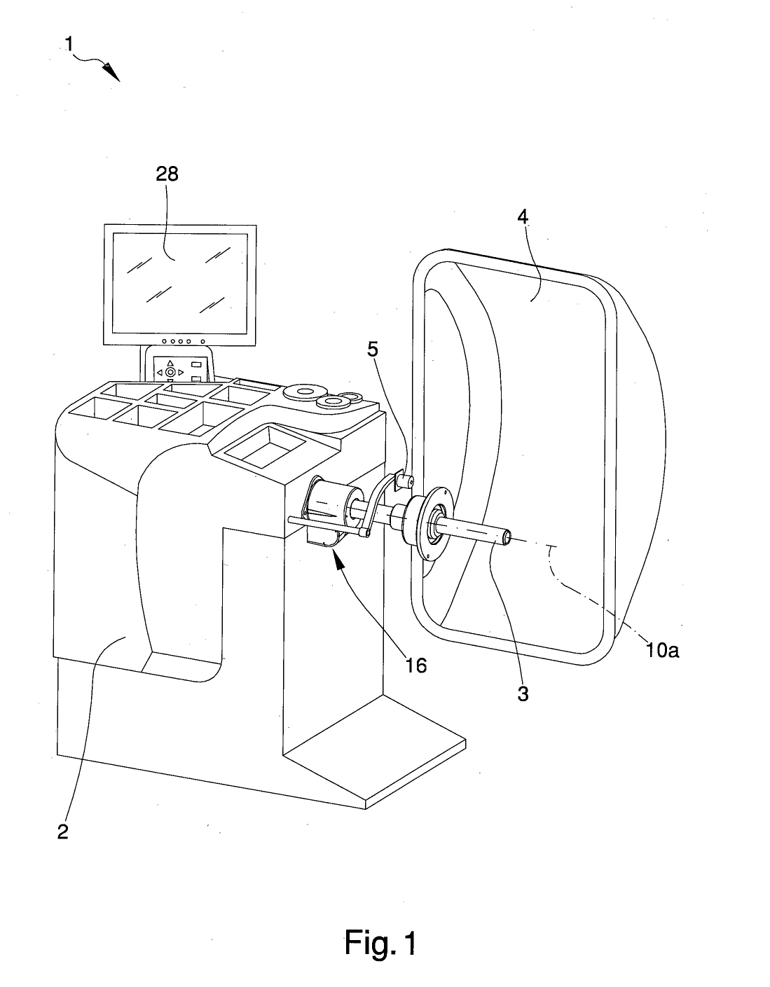

FIG. 2 is a section view of a portion of the machine of FIG. 1;

FIG. 3 is a perspective enlarged view of a detail of the machine of FIG. 2;

FIG. 4 is a functional diagram of the machine of FIG. 1.

### EMBODIMENTS OF THE INVENTION

With particular reference to such figures, globally indicated by 1 is a machine for balancing the wheels of a vehicle by means of compensation weights.

The machine 1 comprises a supporting frame 2 with which a shaft 3 is associated mobile in rotation around a relative axis. The frame 2 generally supports motor means suitable for placing in rotation the shaft 3.

The shaft 3 is intended to coaxially support a wheel 10 to be balanced, which is kept in position by means of fixing means not shown in the illustrations.

By the term wheel used here is meant the assembly made up of the rim 11 and the tyre 12 fitted on the rim itself. The wheel axis is identified by the reference number 10a in the illustrations.

The rim 11 in turn is composed of a radial portion 13, having a central hole for coupling with the vehicle parts and through which the shaft 3 is inserted, of a substantially cylindrical portion 14 on the outer surface of which the tyre 12 is fitted.

The inner surface of the cylindrical portion 14 has at least two areas 14a and 14b intended to be turned towards the inside and towards the outside, respectively, when the wheel 10 is fitted on the vehicle. Preferably, the first area 14a has a diameter larger than that of the second area 14b.

As already said above, the rim 11 is fitted over the shaft 3 through the hole obtained on its radial portion 13 and is blocked with respect to the shaft itself by means of the fixing means.

Suitably, the machine 1 comprises a protection guard 4 associated with the frame 2 and movable to cover at least the upper portion of the wheel 10 in order to safeguard the operator.

The machine 1 then comprises identification means 5 for identifying at least a balancing plane arranged substantially at right angles to the axis 10a of the wheel and which locates at least a balancing profile 6 on the relative rim 11.

The balancing profile 6 therefore corresponds to the intersection between the balancing plane and the rim 11 and identifies all the points along which the balancing weights are to be positioned suitable for correcting the wheel unbalance.

In the particular, but not limitative embodiment shown in the illustrations, the identification means 5 comprise a mechanical feeler which is mobile with respect to the frame 2, both in translation, along a movement direction 5a, and in rotation, around a relative axis 5b.

The balancing profile 6 therefore corresponds to the, circumference deriving from the intersection of the balancing plane arranged at right angles to the axis 10a of the wheel 10 and passing through the contact point between the feeler 5 and the rim 11 with the rim itself.

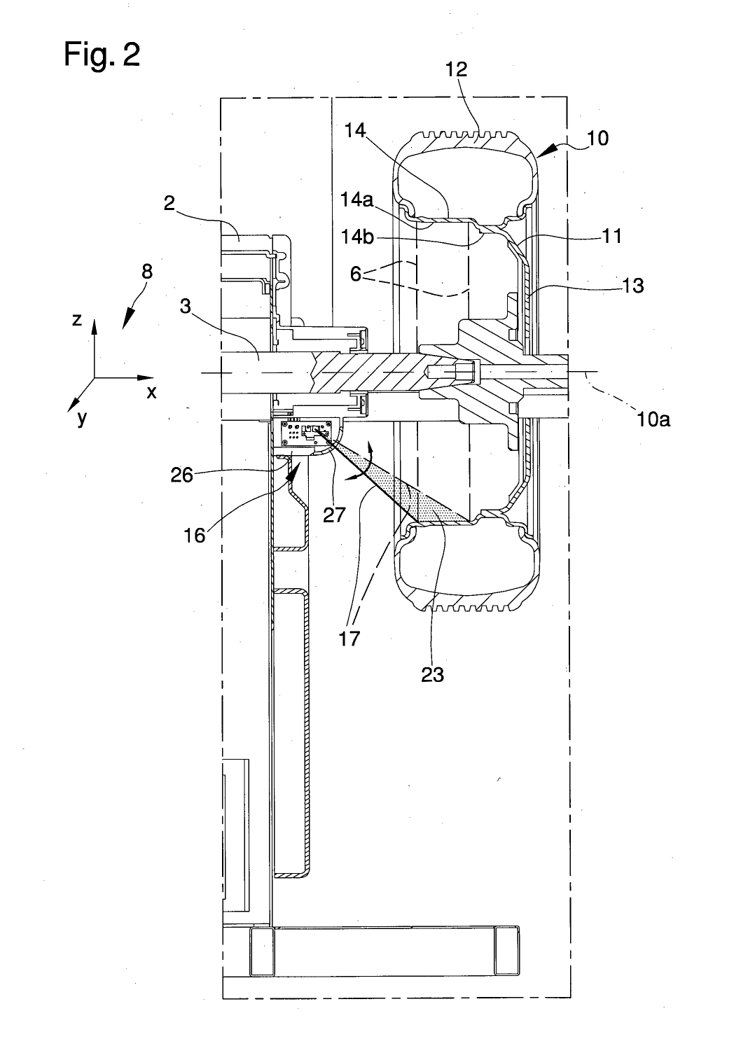

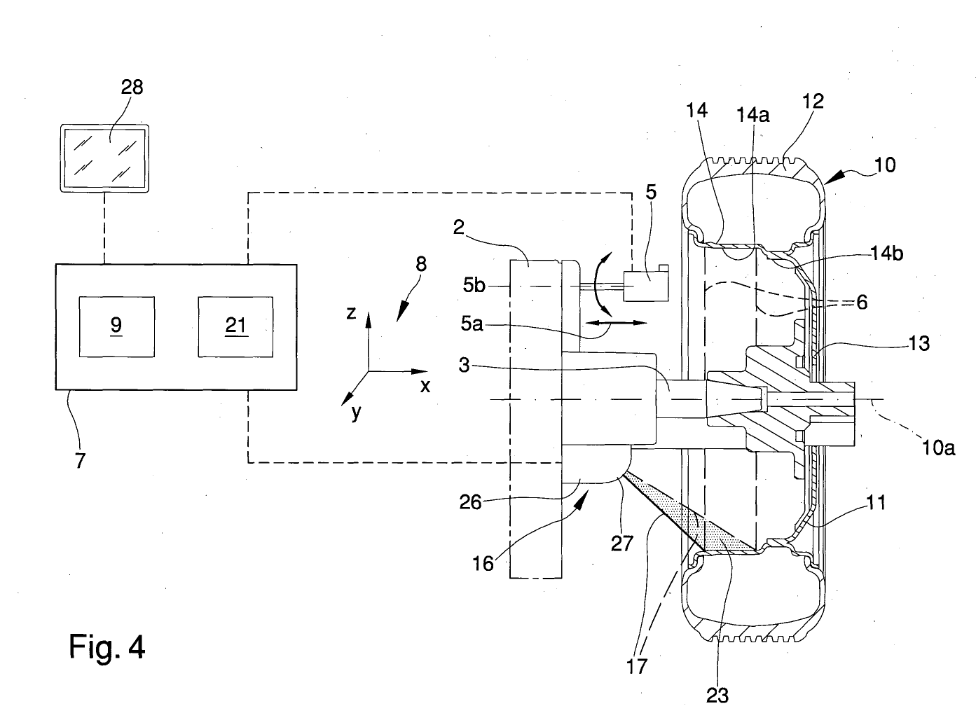

The identification means 5 are operatively connected to a processing unit 7 suitable for detecting the position of the balancing plane, and therefore of the relative profile 6, with respect to a reference system predefined and fixed with respect to the machine 1, identified in the FIGS. 2 and 4 by the reference number 8. The processing unit 7 thus identifies the balancing profile 6 corresponding to the point of contact of the feeler 5 with the inner surface of the cylindrical portion 14.

Alternative embodiments cannot however be ruled out wherein the identification means 5 comprise means for scanning the profile of the rim 11, also called pick-up means.

The machine 1 comprises means for measuring the unbalance of the wheel 10. More in particular, such measurement means (which are not shown in detail in the illustrations and which are of the type known to the technician in the sector) comprise force transducer means suitable for measuring the unbalance of the wheel 10 when this is made to rotate around the shaft 3.

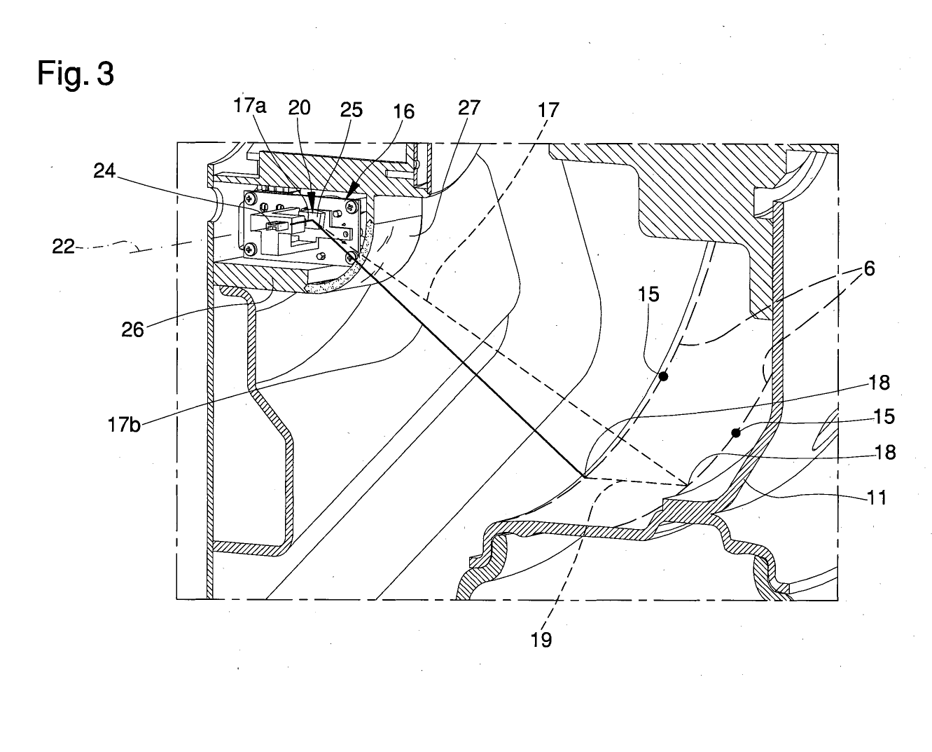

The measurement means are also operatively connected to the processing unit 7. The processing unit 7 then comprises calculation means 9 for calculating the weight of the compensation weights to be fitted along the balancing profile 6 and their angular position along the profile itself. The calculation means 9 therefore identify at least one application point of the compensation weight, identified by the number 15 in FIG. 3, along the balancing profile 6. The processing unit 7 is therefore suitable for processing the information received from the identification means 5 and from the measurement means, to calculate the weight and the correct angular position of the compensation weights along the balancing profile 6. The application points 15 of the compensation weights can also be more than one and, in a particular embodiment, their position can be preset by the operator, a special software splitting up the weight of the compensation weights to be fitted at each set point. The processing unit 7 therefore also detects the angular position of the application point 15 with respect to the reference system 8, the position of the relative balancing plane already being known.

The machine 1 also comprises an optical device 16 suitable for emitting a luminous beam, identified in the figures from 2 to 4 by the reference number 17, which locates a luminous point 18 on the rim 11. The luminous point 18 therefore corresponds to the projection of the luminous beam 17 on the rim 11 and its dimension depends on the conformation and on the inclination of the luminous beam itself. Such luminous beam 17 is suitable for identifying a fixed reference position with respect to the machine 1 and in correspondence to which the operator wishes to apply the compensation weights.

Advantageously, the reference position is preset by the operator according to the accessibility to the inner surface of the rim 11. Preferably, the reference position is chosen in correspondence to the lower area of the rim 11. More in detail, a reference line 19 is preset, fixed with respect to the machine 1 and intersecting the rim 11 and the reference position corresponds to the intersection of the balancing profile 6 with such reference line 19. The position of the reference line 19 is e.g. preset in the memory of the processing unit 7.

The machine 1 also comprises movement means 20 for moving the luminous beam 17 with respect to the rim 11 suitable for carrying the luminous point 18 in correspondence to the balancing profile 6.

The optical device 16 is also operatively connected to the processing unit 7.

The processing unit 7 is therefore able to know and compare the position of the balancing plane, the application point 15 and the luminous point 18 with respect to the reference system 8.

The processing unit 7 comprises command means 21 suitable for operating the movement means 20 so as to bring the luminous point 18 in correspondence to the balancing profile 6 according to their respective positions.

Suitably, the processing unit 7 is suitable for activating signalling means, of the acoustic and/or visual type, the moment the position of the application point 15 corresponds to the reference position preset by the operator, i.e., to the position of the luminous point 18.

According to the invention, the movement means 20 are suitable for rotating the luminous beam 17 with respect to the rim 11 around a relative axis, the latter being identified in the illustrations by the reference number 22.

The direction of the luminous beam 17 is therefore mobile in rotation with respect to the rim 11 around the axis 22.

Advantageously, the axis 22 around which the luminous beam 17 rotates is arranged substantially transversal to the axis 10a of the wheel 10.

More in detail, the axis 22 around which, the luminous beam 17 rotates is arranged substantially at right angles to the axis 10a of the wheel 10.

The movement means 20 are suitable for rotating the luminous beam 17 along at least a circular sector 23 which intercepts the rim 11 along the preset reference line 19. The angular position of such circular sector 23 with respect to the frame 2 is adjustable so as to adapt to a position other than the preset reference line 19.

The processing unit 7 is therefore able to determine the position of the luminous point 18 with respect to the reference system 8 knowing the position of the preset reference line 19 along which the luminous point itself moves, and knowing the angular position of the movement means 20 with respect to the axis 22.

Preferably, the optical device 16 comprises at least a light source 24 suitable for emitting the luminous beam 17 and fixed with respect to the frame 2.

In the embodiment shown in the illustrations, the movement means 20 comprise reflection means 25 of the luminous beam 17 which are mobile in rotation around the axis 22.

More in particular, the light source 24 is associated integral with the frame 2 while the reflection means 25 are associated mobile in rotation around the frame itself.

Suitably, the movement means 20 also comprise motor means (not visible in the illustrations) suitable for operating the reflection means 25 in rotation around the axis 22. The motor means are, e.g., made up of an electric motor of the step-by-step type.

The processing unit 7 is connected e.g. to the shaft of the electric motor which operates the reflection means 25 in rotation and from which it receives a signal relating to the angular position of the reflection means themselves and, knowing the previously-determined geometric dimensions of the rim 11, is able to precisely identify the position of the luminous point 18 with respect to the reference system 8.

The reflection means 25, e.g. made up of a mirror, comprise a reflecting surface arranged inclined with respect to the direction of origin of the luminous beam 17 emitted by the light source 24.

Suitably, the reflection means 25 rotate around the axis 22 along a limited arc of rotation, in such a way as to move the luminous beam 17 along the above-mentioned circular sector. The angular position of the reflection means 25 with respect to the light source 24 can be adjusted to change the direction of the luminous beam 17, and therefore of the circular sector described by same, with respect to the machine 1.

More in detail, the luminous beam 17 comprises a first portion 17a placed between the light source 24 and the reflection means 25 and a second portion 17b coming out of the latter and which intercepts the rim 11.

As can be seen in the FIGS. 2 and 3, the direction of the first portion 17a is fixed and substantially perpendicular to the axis 10a of the wheel 10 while the second portion 17b is mobile around the axis 22 along a plane substantially parallel to the axis 10a of the wheel 10 and transversal with respect to the axis 22.

The optical device 16 is contained inside a boxed casing 26 associated integral with the frame 2 and comprising a transparent portion 27 suitable for allowing a luminous beam 17 to pass through towards the rim 11. The transparent portion 27 has a curvilinear extension and its extension is such as to cover the entire arc of rotation completed by the reflection means 25.

In the event of having to perform dynamic balancing, as already said above, the identification means are suitable for identifying at least two balancing planes 6 spaced from one another along the axis 10a of the wheel.

In the embodiment shown in the illustrations, the operator contacts with the feeler 5 two areas of the inner surface of the cylindrical portion 14 staggered along the axis 10a, with each of which a relative balancing profile 6 is associated.

In the same way, in the event of dynamic balancing of the wheel 10 being performed, the calculation means 9 calculate the weight and the angular position of the application point 15 of the compensation weights for each identified balancing profile 6.

Advantageously, the movement means 20 can be operated to move the luminous point 18 from one balancing profile 6 to the other, so as to identify two respective reference positions. The command means 21 of the processing unit 7 therefore operate the movement means 20 to change the position of the luminous point 18 bringing it onto the balancing profile 6 of interest. Both the reference positions identified by the luminous point 18 belong to the reference line 19 along which the luminous point itself moves.

In particular, the operator identifies, by means of interface means, the balancing profile 6 of interest and the processing unit 7 compares the angular position of the relative application point 15 with that of the luminous point 18, both belonging to the same balancing plane. The interface means also comprise a monitor 28 suitable for displaying the information received and processed by the processing unit 7.

The operation of the equipment in carrying out the procedure according to the invention provides for at least an identification phase of at least a balancing plane on the rim 11 of the wheel 10 to be balanced and in correspondence to which one or more compensation weights are to be fitted, the balancing plane being arranged substantially at right angles to the axis 10a of the wheel 10 and identifying a balancing profile 6 on the relative rim 11.

Subsequently, a measuring phase of the unbalance of the wheel 10 is performed. The weight is then calculated of the compensation weights to be fitted along the balancing profile 6 and the angular position of the respective application points 15.

The method according to the invention then provides for an emission phase of a luminous beam 17 which identifies a luminous point 18 on the surface of the rim 11 suitable for identifying a fixed reference position with respect to the machine 1 and in correspondence to which the operator intends applying the compensation weights for correcting the unbalance of the wheel 10.

Subsequently, the luminous beam 17 is moved so as to move the luminous point 18 in correspondence to the balancing profile 6, where such movement is performed by turning the luminous beam 17 around a relative axis 22 with respect to the rim 11.

The luminous beam 17 is then rotated until the position of the luminous point 18, with respect to the reference system 8, arrives in correspondence to the balancing profile 6, or until it belongs to the selected balancing plane. Such detection is made by the processing unit 7, which knows the position of the balancing plane and, by detecting the angle of the reflection means 25, also knows the position of the luminous point 18, the latter moving along the preset reference line 19.

Suitably, the wheel R must also be moved so as to move the application point 15 of the compensation weights in correspondence to the preset reference position. This phase is performed by comparing, e.g., by means of the processing unit 7, the position of the application point 15 to the reference position. The application point 15 is then moved from the position in which it finds itself at the end of the wheel unbalance measuring phase as far as the reference position.

The movement phases of the wheel 10 and of the luminous beam 17 can be performed in any order, its being preferable to first move the luminous beam 17 and then the wheel 10. The reference position is not in fact visible to the operator and is identified by the luminous point 18 once this arrives in correspondence to the balancing profile 6.

Subsequently, the compensation weights are fitted in correspondence to the luminous point 18.

In the event of dynamic balancing of the wheel 10 being performed, the luminous beam 17 is rotated to bring the luminous point 18 in correspondence to the required balancing profile 6.

The operator then performs the above operations for each identified balancing profile 6, meaning he/she positions the luminous point 18 in sequence on each balancing profile 6 and fits the compensation weights at the point indicated by same after turning the wheel 10 in such a way that the position of the relative application point 15 coincides with that of the luminous point itself.

It has in practice been ascertained how the invention achieves the proposed objects and in particular the fact is underlined that it permits identifying the reference position in correspondence to which the operator intends applying the compensation weights on the rim in an easy and practical way.

More in detail, the machine according to the invention allows identifying the reference position relating to each balancing profile without interfering in any way with the activities of the operator charged with applying the compensation weights.

Again, the machine according to the invention also provides reliable operation, inasmuch as the light source emitted by the luminous beam is, in use, fixed with respect to the machine and contained inside a relative boxed casing, and consequently it is protected against interaction with other external bodies.

The solution forming the subject of the present invention is therefore considerably simpler from a construction viewpoint and easier to use than those known to date.

1-13. (canceled)

14. Machine (1) for balancing the wheels of a vehicle, comprising:
a supporting frame (2);
at least one shaft (3) associated mobile in rotation with said frame (2) and intended to support a wheel (10) to be balanced of a vehicle;
identification means (5) for identifying at least a balancing plane arranged substantially at right angles to the axis (10a) of the wheel (10) and which locates a balancing profile (6) on the relative rim (11);
measurement means for measuring the unbalance of the wheel (10);
at least an optical device (16) suitable for emitting a luminous beam (17) which locates a luminous point (18) on the surface of the rim (11), wherein said luminous point (18) is suitable for identifying a fixed reference position compared to the machine itself and in correspondence to which the operator wishes to apply the compensation weights for the unbalance of the wheel (10); said optical device (16) comprising movement means (20) for moving the luminous beam (17) which can be operated to carry said luminous point (18) in correspondence to said balancing profile (6);
wherein said movement means (20) are suitable for rotating said luminous beam (17) with respect to said rim (11) around a relative axis (22) and comprise reflection means (25) for reflecting the luminous beam which are mobile in rotation with respect to said frame (2) around said rotation axis (22).

15. The machine (1) according to claim 14, wherein the rotation axis (22) of said luminous beam (17) is arranged substantially transversal to the axis (10a) of the wheel (10).

16. The machine (1) according to claim 14, wherein said movement means (20) are suitable for rotating said luminous beam (17) along at least a circular sector (23) suitable for intercepting the rim along at least a preset reference line (19).

17. The machine (1) according to claim 16, wherein the angular position of said circular sector (23) with respect to said frame (2) is adjustable.

18. The machine (1) according to claim 14, wherein the light source (24) suitable for emitting said luminous beam (17) is fixed with respect to the machine itself.

19. The machine (1) according to claim 18, wherein said optical device (16) is contained within a protection boxed casing (26).

20. The machine (1) according to claim 14, wherein said reflection means (25) comprise at least a reflecting surface inclined with respect to the direction of incidence of the luminous beam (17) emitted by said light source (24).

21. The machine (1) according to claim 14, wherein said identification means (5) are suitable for identifying at least two balancing planes (6) spaced from one another along the axis (10a) of the wheel (10) and that said reflection means (25) can be operated in rotation to move said luminous point (18) between said balancing profiles (6).

22. Method for balancing the wheels of a vehicle, comprising the following steps of:
providing a wheel (10) to be balanced;
providing a balancing machine (1) comprising a supporting frame (2) and a shaft (3) associated mobile in rotation with said frame (2) and suitable for supporting said wheel (10) to be balanced;
identification of at least one balancing plane on the rim (11) of said wheel (10) and in correspondence to which one wishes to apply one or more compensation weights, said balancing plane being arranged substantially at right angles to the axis (10a) of the wheel (10) and locating a relative balancing profile (6) on the rim (11);
measurement of the unbalance of the wheel (10);
emission of a luminous beam (17) which locates a luminous point (18) on the surface of said rim (11) suitable for identifying a fixed reference position compared to said balancing machine (1) and in correspondence to which the operator wishes to apply the compensation weights for the unbalance of the wheel (10);
movement of said luminous beam (17) so as to carry said luminous point (18) in correspondence to said balancing profile (6);
wherein said movement is performed by rotating said luminous beam (17) with respect to said rim (11) around a relative axis (22), said rotation of the luminous beam (17) being performed by keeping fixed the light source (24) of the luminous beam itself.

23. The method according to claim 22, wherein it comprises the steps of:
identification of at least two of said balancing planes separate from one another and staggered along the axis (10a) of the wheel (10), each of said balancing planes locating a relative balancing profile (6);
rotation of said luminous beam (17) so as to move said luminous point (18) between said balancing profiles (6).

24. The method according to claim 22, wherein it comprises a setting stage of at least a fixed reference line (19) with respect to said machine (1) and intersecting said rim (11) and by the fact that said rotation of the luminous beam (17) is performed so as to move the relative luminous point (18) along said reference line (19).
